(19) United States
(12) Patent Application Publication
(10) Pub. No.: US 2006/0152752 A1
(43) Pub. Date: Jul. 13, 2006

(54) Log-in method for a client server system, a computer program, and a recording medium

(75) Inventors: Naoya Yamaguchi, Tokyo (JP); Kenji Goshima, Tokyo (JP)

Correspondence Address: SEED INTELLECTUAL PROPERTY LAW GROUP PLLC, 701 FIFTH AVE, SUITE 6300, SEATTLE, WA, 98104-7092, US

(73) Assignee: TDK Corporation, Tokyo (JP)

(21) Appl. No.: 10/525,330

(22) PCT Filed: Jul. 31, 2003
(86) PCT No.: PCT/JP03/09767

§ 371 Date: Feb. 23, 2005

(30) Foreign Application Priority Data
Aug. 23, 2002 (JP) 2002-243140

(51) Int. Cl. G06F 3/12

(52) U.S. Cl. 358/1.15

(57) ABSTRACT

The present invention relates to a log-in method for a client server system which enables a client computer to log in to a server accessible via either the Internet or a LAN with high security and operability. When a server 101 receives a connection request from a client computer 102, the server 101 obtains an IP address of the client computer 102 and judges based on the IP address a network to which the client computer 102 is connected. When the server 101 judges that the client computer 102 is a client computer 102c connected to the Internet 105, the server 101 causes the client computer 102 to display a first log-in screen. On the other hand, when the server 101 judges that the client computer 102 is a client computer 102a or 102b connected to the LAN 102, the server 101 causes the client computer 102 to display a second log-in screen which can be more easily operated than the first log-in screen.

### BACKGROUND OF THE INVENTION

1. Field of the Invention

The present invention relates to a log-in method for a client server system and particularly, to a log-in method for a client server system which enables a client computer to log in to a server accessible via either the Internet or a LAN with high security and operability, a computer program for executing the log-in method and a recording medium in which the computer program is stored.

2. Description of the Related Art

Recently, the teaching of lessons using personal computers and education for enhancing information literacy are being actively conducted as part of grade school teaching. A number of personal computers each connected to a LAN and the Internet are installed in a grade school and a system environment easy for elementary school students to use is set up. In a grade school, the students operate personal computers to send emails to teachers or other students, browse a bulletin board or a class newspaper, or post their own homepages on a network.

It is possible to browse the bulletin board or the like and post homepages on the network by accessing a server connected to a LAN installed at the grade school. The server normally requires the user to input a log-in name and a password when the LAN is logged in to from a personal computer and allows him or her to access the server when they are correct, so that only the teachers, grade school students or related persons can access the server and unspecified users cannot access it.

In order to log in to the LAN from the client computer, a log-in name and password are ordinarily entered in text boxes, namely, the direct input method is employed.

However, this method is often inconvenient for a child in the lower grades of elementary school when logging in to a server from a personal computer connected to a LAN in a school. Specifically, since such a child is not familiar with the operation of a keyboard and often does not know the letters of the alphabet, it is difficult for him or her to directly input a log-in name or a password in a text box.

Therefore, there is sometimes employed a method (a selection method) which requires a user to directly input only a password between a log-in name and a password and to select a log-in name from those displayed on a screen. According to this method, since a log-in name can be specified only by operating a mouse without operating a keyboard, it is possible to simplify the log-in operation.

However, in the case of logging in to the server via the Internet, persons other than grade school students can freely access the server, so that it is necessary to be more careful about the security of the log-in operation than in the case of logging in to the server via a LAN. Therefore, in such a case, it is not preferable from the viewpoint of security to display a list including log-in names of other persons so that log-in names of other persons can be easily known.

### BRIEF SUMMARY OF THE INVENTION

It is therefore an object of the present invention to provide a log-in method for a client server system which enables a client computer to log: in to a server accessible via the Internet or a LAN with high security and operability, a computer program for performing the log-in method and a recording medium in which the computer program is stored.

The above object of the present invention can be accomplished by a log-in method for a client server system constituted so as to display a predetermined log-in screen on a client computer, the server being constituted so as to obtain identification data of the client computer in response to a connection request from the client computer, judge based on the identification data of the client computer a network to which the client computer is connected, display a first log-in screen on the client computer when it judges that the network to which the client computer is connected is a first network, and display a second log-in screen on the client computer when it judges that the network to which the client computer is connected is a second network.

According to the present invention, since the server judges what network the client computer which wishes to log in is connected and displays a log-in screen on the client computer depending upon the result of the judgment, the level of difficulty of the log-in operation of the client computer can be determined depending upon the client computer and it is therefore possible to provide a log-in method for a client server system which enables a client computer to log in to a server accessible via the Internet or a LAN with high security and operability.

For example, in a client server system including a server connected to a LAN installed in a grade school and to the Internet, in the case where a child in the lower grades of elementary school logs in the server from a client computer connected to the installed LAN, considering that the child is not familiar with the operation of a keyboard and does not understand letters of the alphabet, it is very advantageous for the child to provide a convenient system to enable him or her to more simply log in the server than in the case of logging in to the server via the Internet. On the other hand, in the case of logging in to the server via the Internet, since persons other than the grade school students can freely access the server, it is very advantageous for improving the security level to require the user to perform a more difficult log-in operation than in the case of logging in to the server via the LAN.

In a preferred aspect of the present invention, the second log-in screen is constituted so that it can be used more easily than the first log-in screen.

According to this preferred aspect of the present invention, since the level of difficulty of the log-in operation is determined depending upon the level that it is necessary to restrict access from the network to the server, it is possible to provide a log-in method which enables a client computer to log in to a server with high security and operability.

In a further preferred aspect of the present invention, the first log-in screen is adapted to be directly input with both a log-in name and a password of a user and the second log-in screen is constituted so as to require a user to select a log-in name of the user and directly input a password of the user.

According to this preferred aspect of the present invention, since a method which requires a user to directly input both the log-in name and the password of the user is employed in the first log-in screen and a method which requires the user to directly input only the password of the user but to-select the log-in name of the user is employed in the second log-in screen, it is possible to provide a log-in method depending upon the level of the security of a network.

In a further preferred aspect of the present invention, the first log-in screen is adapted to be directly input with both a log-in name and a password of a user and the second log-in screen is constituted so as to require a user to select a log-in name of the user in accordance with an auto-complete format and to directly input a password of the user.

According to this preferred aspect of the present invention, since a method which requires a user to directly input both a log-in name and a password of the user is employed in the first log-in screen and a method which requires the user to directly input only the password of the user but to select a log-in name of the user in accordance with an auto-complete format is employed in the second log-in screen, it is possible to provide a log-in method depending upon the level of the security of a network.

In a preferred aspect of the present invention, the level of access restriction to the second log-in screen from a network is determined to be higher than that to the first log-in screen.

According to this preferred aspect of the present invention, since the level of difficulty of the log-in operation is determined depending upon the level that it is necessary to restrict access from the network to which the client computer is connected, it is possible to provide a log-in method which enables a client computer to log in to a server with high security and operability.

In a further preferred aspect of the present invention, the server is constituted so as to refer to a list in which at least the identification data of the client computer connected to the second network is registered when it judges a network the client computer is connected to based on the identification data.

According to this preferred aspect of the present invention, since the relationship between the identification data and the network is registered in a list and the network the client computer is connected to is judged by referring to the relationship between the identification data and the network registered in the list, it is possible to easily and reliably judge the network the client computer is connected to. Further, it is possible for an administrator of a machine or a network to set and change the level of access restriction of each of the client computers on the list.

In a preferred aspect of the present invention, the first network is constituted as the Internet and the second network is constituted as a local area network.

According to this preferred aspect of the present invention, since whether the client computer which wishes to log in to is connected to the Internet or a local area network is judged and the level of difficulty of the log-in operation is determined based on the result of the judgment, it is possible to provide a log-in method in which security and operability can be simultaneously improved.

In a further preferred aspect of the present invention, the identification data are constituted as an IP address and the server is constituted so as to refer to an address list in which at least IP addresses of client computers connected to the local area-network are registered, judge that when the IP address is registered in the address list, a client computer having the IP address is connected to the local area network and judge that when the IP address is not registered in the address list, a client computer having the IP address is connected to the Internet.

According to this preferred aspect of the present invention, since whether the client computer which wishes to log in is connected to the server via the Internet or the local area network is judged by referring to the address list it is possible to very easily what network the client computer is connected to without any additional identification data. Further, it is possible for an administrator of a machine or a network to set and change the level of access restriction of each of the client computers on the list.

In a further preferred aspect of the present invention, the identification data are constituted as an IP address and the server is constituted so as to judge that when the IP address is a global IP address, a client computer having the IP address is connected to the Internet and judge that when the IP address is a local IP address, a client computer having the IP address is connected to the local area network.

According to this preferred aspect of the present invention, since whether the client-computer which wishes to log in to is connected to the server via the Internet or the local area network is judged based on the IP address of the client computer, it is possible to judge what network the client computer is connected to based only on the format of the IP address and therefore, it is possible to very easily judge what network the client computer is connected to without any additional identification data.

The above object of the present invention can be also accomplished by a computer-readable recording medium in which is recorded a computer program for enabling a server in a client server system constituted so as to display a predetermined log-in screen on a client computer to execute at least a step of obtaining identification data of the client computer in response to a connection request from the client computer, a step of judging based on the identification data of the client computer a network to which the client computer is connected, a step of displaying a first log-in screen on the client computer when it is judged that the network to which the client computer is connected is a first network, and a step of displaying a second log-in screen on the client computer when it is judged that the network to which the client computer is connected is a second network.

According to the present invention, it is possible to achieve a log-in method in which security and operability can be simultaneously improved by installing the computer program in the server.

The above object of the present invention can be also accomplished by a computer-readable recording medium in which is recorded a computer program for enabling a server in a client server system constituted so as to display a predetermined log-in screen on a client computer to execute at least a step of obtaining identification data of the client computer in response to a connection request from the client computer, a step of judging based on the identification data of the client computer a network to which the client computer is connected, a step of displaying a first log-in screen on the client computer when it is judged that the network to which the client computer is connected is a first network, and a step of displaying a second log-in screen on the client computer when it is judged that the network to which the client computer is connected is a second network.

According to the present invention, it is possible to achieve a log-in method in which security and operability can be simultaneously improved by setting the above defined recording medium in the server of the client server system and installing the computer program in the server.

### BRIEF DESCRIPTION OF THE DRAWINGS

FIG. 1 is a schematic view showing a client server system to which a log-in method which is a preferred aspect of the present invention is applied.

FIG. 2 is a block diagram showing a hardware configuration of a server 101.

FIG. 3 is a view showing a software configuration of a server 101.

FIG. 4 is a view showing one example of a first log-in screen displayed on a client computer 102c when the client computer 102c accesses a server 101.

FIG. 5 is a view showing one example of a second log-in screen displayed on a client computer 102a or a client computer 102b when it accesses a server 101.

FIG. 6 is a flowchart showing steps of the operation of a server 101 when the server 101 is logged in to.

FIG. 7 is a view showing another preferred embodiment of the second log-in screen shown in FIG. 5.

FIG. 8 is a view showing another preferred embodiment of the second log-in screen shown in FIG. 5.

FIG. 9 is a view showing a further preferred embodiment of the second log-in screen shown in FIG. 5.

### DETAILED DESCRIPTION OF THE PREFERRED EMBODIMENTS

Hereinafter, preferred embodiments of the present invention will be described in detail with reference to accompanying drawings.

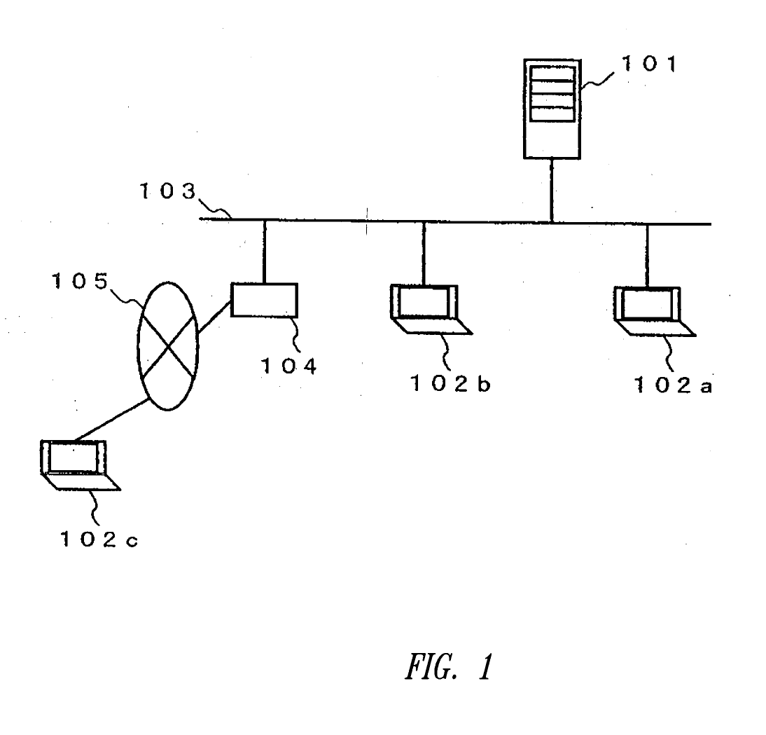

FIG. 1 is a schematic view showing a client server system to which a log-in method which is a preferred aspect of the present invention is applied.

As shown in FIG. 1, the system has a configuration in which a web server 101 and client computers 102a and 102b are connected to a LAN 103. Further, an Internet connection device 104 such as a broad band router is connected to the LAN 103 so that the LAN 103 is connected to the Internet 105 via the broad band router 104 and the client computer 102c is connected to the LAN 103 via the Internet 105. Here, although it is necessary to interpose a modem between the broad band router 104 and the Internet 105 in accordance with how the client server system is connected to the Internet 105, such a modem is omitted in FIG. 1.

The server 101 is constituted so as to provide various services to be supplied from a web server, an FTP server, a POP server and the like. It is preferable for the server 101 to be constituted as a computer having relatively higher processing capacity than that of each of the client computers. In the case where much higher processing capacity is required for the server 101, it is preferable for the server 101 to be constituted as a work station.

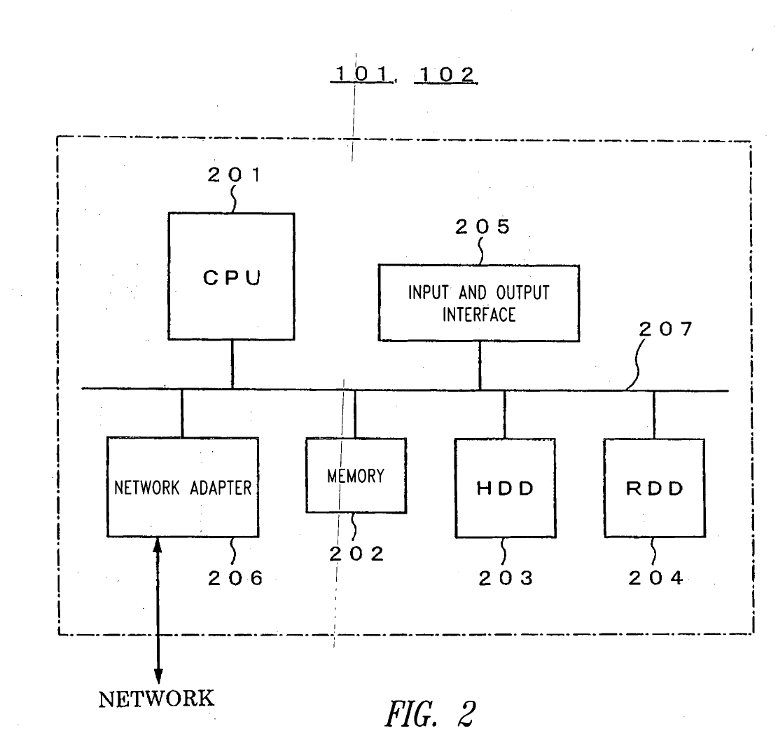

FIG. 2 is a block diagram showing a hardware configuration of the server 101.

As shown in FIG. 2, the server 101 includes a CPU 201, a memory 202, a hard drive disk (HDD) 203, a removable disk drive 204 which can reproduce data from and record data in recording media such as a flexible disk, a CD-ROM, a CD-R, a DVD-ROM or the like, an input and output interface 205 and a LAN adapter 206, which are connected via a bus 207. The server 101 is connected via the input and output interface 205 to a display, a keyboard and the like and is connected via the LAN adapter 206 to the LAN 103. The configuration of the server 101 is substantially the same as that of an ordinary computer.

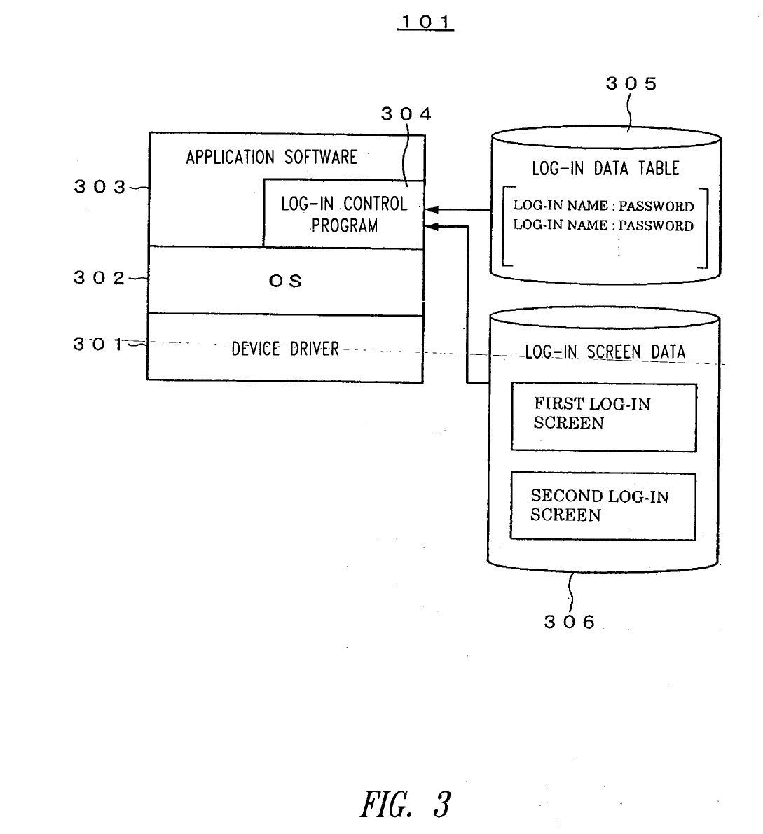

FIG. 3 is a view showing a software configuration of the server 101.

As shown in FIG. 3, the server 101 includes a device driver 301, an operating system (OS) 302 and application software 303. The application software 303 includes a log-in control program 304 for performing a log-in method according to this embodiment as one function of server software. These programs are installed on the hard disk drive 203, read from the hard disk drive 203 when the computer is started or when an executable file is launched, thereby being loaded in a memory and sequentially executed by the computer.

These programs may be supplied in the form of a recording medium such as a CD-ROM storing them, for example. In such a case, the software is installed in the client computers 102a to 102c by setting the recording medium in the removable disk drive 204 and storing it on the hard disk drive 203. Instead, the software may be downloaded via the Internet 105. In such a case, the software is installed in the client computers 102a to 102c by being downloaded via the network adapter 206 and being stored on the hard disk drive 203.

The server 101 further includes in addition to the above mentioned programs a log-in data table 305 which contains the log-in name and password of each user and log-in screen data 306 used to display a log-in screen on the displays of the client computers 102a to 102c when the client computers: 102a to 102c are connected to the server 101.

As each of the client computers 102a to 102c shown in FIG. 1, various terminal devices, a desktop personal computer, a laptop personal computer, a PDA, a cellular telephone or the like can be used. The configuration of each of the client computers 102a to 102c is substantially the same as that of an ordinary computer and therefore, is substantially the same as that of the server 101 shown in FIG. 2. The application software of each of the client computers includes a web browser.

When one of the client computers 102a to 102c accesses the server 101, the server 101 first transmits log-in screen data to the client computer, whereby a log-in screen is displayed on the display thereof.

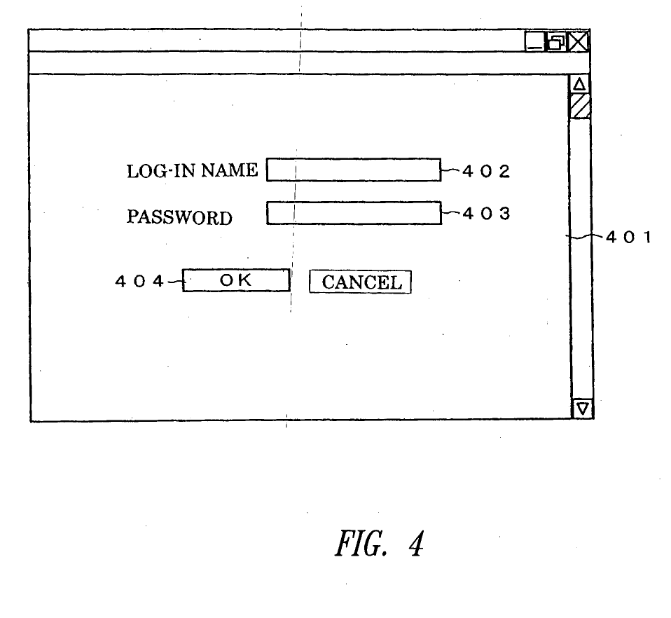

FIG. 4 is a view showing one example of a first log-in screen displayed on the client computer 102c when the client computer 102c accesses the server 101.

As shown in FIG. 4, a first log-in screen 401 for accessing the server 101 via the Internet is displayed on the display of the client computer 102c and the first log-in screen 401 is constituted so that a log-in name and password of the user are to be entered in a text box 402 and a text box 403 thereof, respectively. The user puts a pointer on the text box 402 to which a log-in name is to be input, thereby putting the first log-in screen in text input mode, and enters a log-in name therein. A password is entered similarly. Thereafter, when an “OK” button 404 is clicked, data regarding the log-in name and the password are transmitted to the server 101.

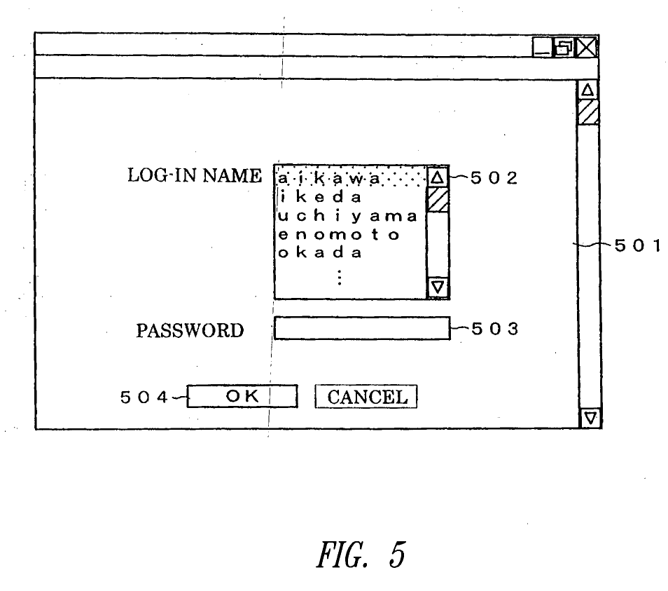

FIG. 5 is a view showing one example of a second log-in screen displayed on the client computer 102a or the client computer 102b when it accesses the server 101.

As shown in FIG. 5, a second log-in screen 501 for accessing the server 101 via the LAN, which can be more easily operated than the first log-in screen, is displayed on the display of the client computer 102a or the client computer 102b. The second log-in screen 501 is so constituted that a log-in name is selected from a list 502 and a password is directly input to a text box 503. Specifically, when a log-in name is to be entered, the user selects a log-in name from the list 502 and puts a pointer on and clicks the thus selected log-in name. On the other hand, when a password is to be entered, the user puts the pointer on the text box 503 into which the password is to be entered, thereby putting the second log-in screen 501 in the text input mode, and directly enters the password therein. Thereafter, when the “OK” button 504 is clicked, data regarding the log-in name and the password are transmitted to the server 101.

In order to judge whether the client computer which wishes to log-in is connected to the LAN or the Internet, an IP address is referred to as identification data.

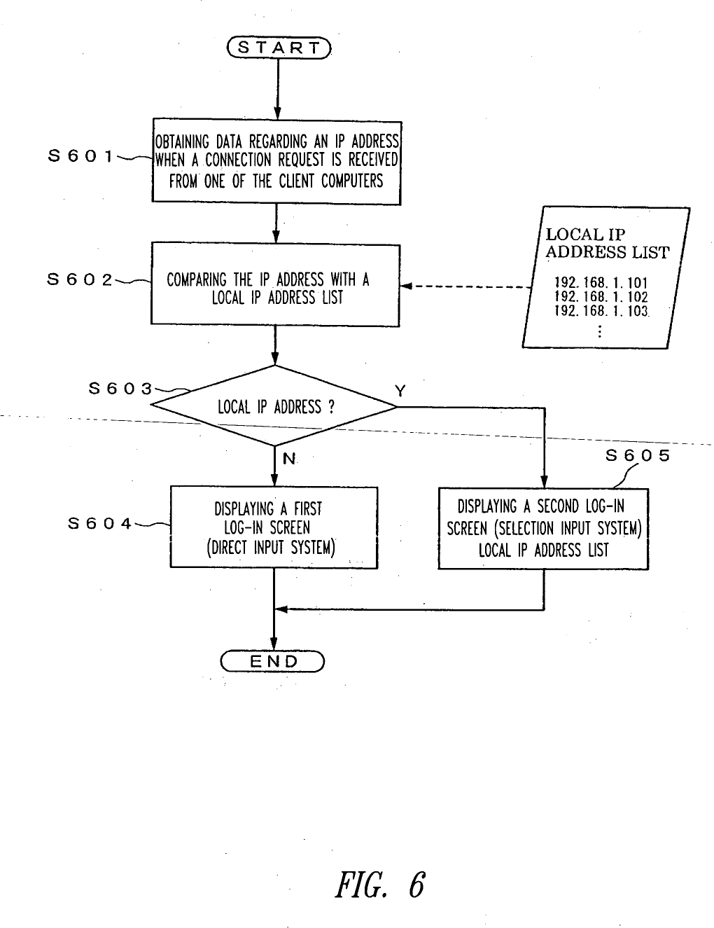

FIG. 6 is a flowchart showing steps of the operation of the server 101 when the server 101 logs in.

As shown in FIG. 6, when the server 101 receives a connection request from one of the client computers, the server 101 first obtains data regarding an IP address contained in a packet transmitted from the client computer (S601).

The server 101 then compares the thus obtained IP address with an address list stored therein (S602). Here, local IP addresses of the client computers connected to the LAN are recorded in the address list. Therefore, the server 101 can judge by comparing the IP address with the address list whether the IP address is a local IP address or a global IP address.

In the case where the server 101 judges that the IP address is a global IP address (S603N), the server 101 transmits screen data to the client computer so as to cause the client computer to display a log-in screen (the first log-in screen) shown in FIG. 4 so constituted that both a log-in name and a password are to be directly entered (S604).

On the other hand, in the case where the server 101 judges that the IP address is a local IP address (S603Y), the server 101 transmits screen data to the client computer so as to cause the client computer to display a log-in screen (the second log-in screen) shown in FIG. 5 so constituted that a log-in name is to be selected from a list displayed therein and only a password is to be directly entered (S605).

In this embodiment, since what network the client computer which wishes to log in is connected is judged and the level of difficulty of the log-in operation of the client computer can be determined based on the result of the judgment, it is possible to provide a log-in method in which the security and operability can be simultaneously improved.

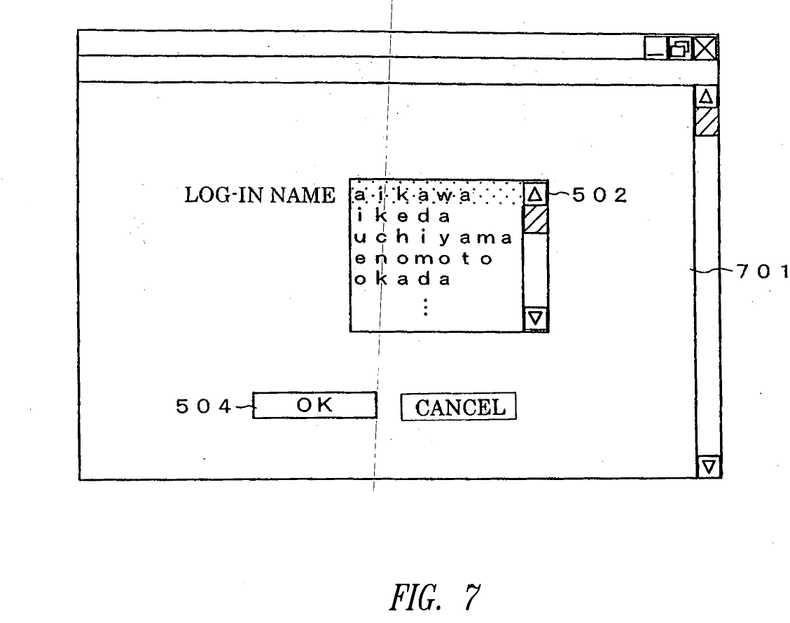

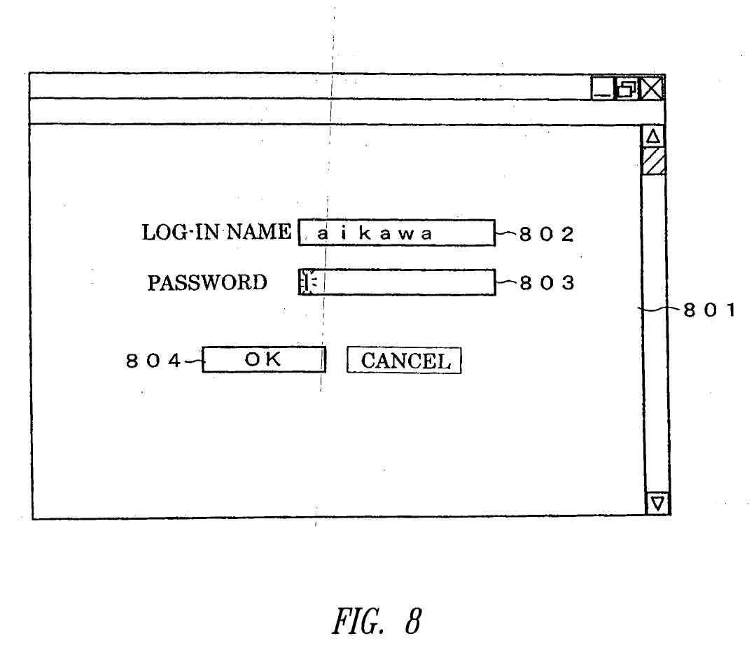

FIGS. 7 and 8 are views showing another embodiment of the second log-in screen shown in FIG. 5.

As shown in FIGS. 7 and 8, in this embodiment, only a list of log-in names is displayed and when a log-in name has been selected, a screen constituted so that a password is to be directly entered therein is displayed.

As shown in FIG. 7, when a connection request is made, a log-in screen 701 including only a list 502 and no text box for password input is displayed. When the log-in name of the user has been selected from the list 502, then, as shown in FIG. 8, a screen 801 including the log-in name 802 and a text box 803 for password input is displayed. When the password of the user has been entered and an “OK” button 804 is clicked, data regarding the log-in name and the password are transmitted to the server 101. Here, it is not absolutely necessary to transmit the log-in name and the password at the same time and the log-in name and the password may be transmitted separately to the server in such a manner that the log-in name is first transmitted when it is selected and then the password is transmitted when it is entered.

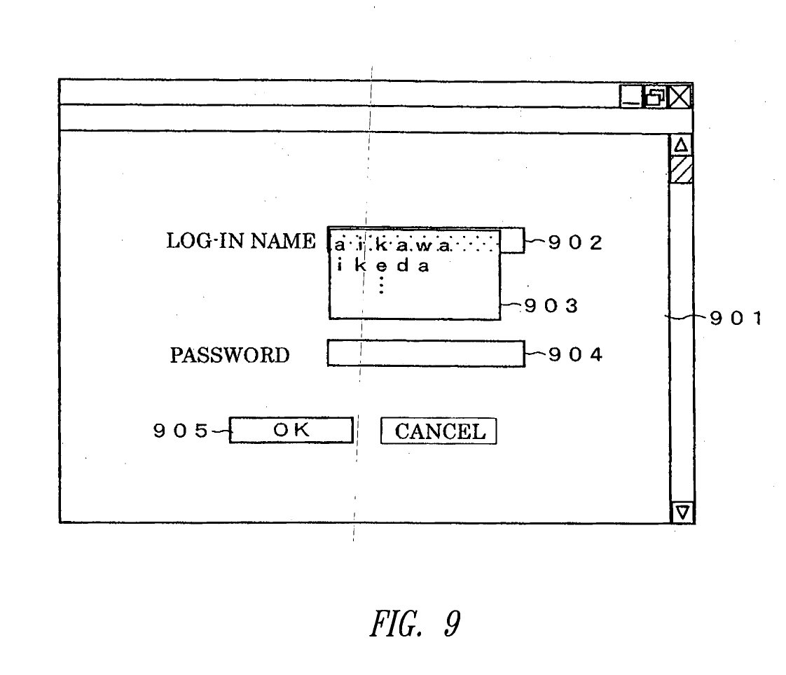

FIG. 9 is a view showing a further preferred embodiment of the second log-in screen shown in FIG. 5.

As shown in FIG. 9, in this embodiment, similarly to in the above described embodiments, a log-in screen for accessing the server 101 via the LAN, which can be more easily operated than the first log-in screen, is displayed on the client computers 102a and 102b. However, in this embodiment, when a log-in name is selected from the list, the log-in name is selected in accordance with an auto-complete format. In the auto-complete format, when the first character of a log-in name is entered in the text box, a plurality of possible log-in names having the same character as the first character are displayed in the form of a list and when the second character, third character and so on of the log-in name are further input, possible log-in names are displayed.

Specifically, as shown in FIG. 9, after the user puts the pointer on the text box to which a log-in name is to be entered and puts the screen in text input mode, then, when the user enters the first character of a log-in name, possible log-in names having the same character as the first character are displayed in a drop down list 903. When the user puts the pointer on the log-in name to be selected from the drop down list 903 and clicks the log-in name, the log-in name is selected. On the other hand, since it is not preferable form the viewpoint of security for a password to be selected from a list, the password is directly entered in a text box 904 by the user. This operation is the same as that in FIG. 5. Thereafter, when the user clicks an “OK” button 905, data regarding the log-in name and the password are transmitted to the server 101.

The present invention has thus been shown and described with reference to specific embodiments. However, it should be noted that the present invention is in no way limited to the details of the described arrangements but changes and modifications may be made without departing from the scope of the appended claims.

For example, in the above described preferred embodiments, although the explanation was made as to the case where the two networks are the Internet and a LAN, it is not absolutely necessary for the two networks to be the Internet and a LAN and both networks may be LANs. In other words, the present invention can be applied to a system in which a server is logged in to from client computers via any two networks whose security levels are different.

Furthermore, in the above described preferred embodiment, although it is judged that a connection request was made from a client computer connected to the LAN when the IP address is a local IP address and a corresponding log-in screen is provided, the present invention can be applied to the case where global IP addresses are assigned to client computers connected to a LAN. For example, even in the case where access to a network is restricted from the outside by a fire wall or a proxy server, in other words, in the case where global IP addresses are assigned to client computers connected to a LAN, if the IP addresses are registered in the above mentioned address list, it is possible to judge the kind of the network by referring to the address list.

Moreover, in the above described preferred embodiments, although the explanation was made as to the case where an IP address is used as identification data, it is not absolutely necessary to use an IP address as identification data and a MAC address or other identification data may be used as identification data of a client computer. Specifically, it is sufficient for identification data of a client computer to be identification data by which it can be judged whether the client computer is attempting to access via a first network or a second network, and identification data of a client computer include not only identification data on the Internet such as an IP address but also individual data of a client computer such as a MAC address. Further, identification data used only for selecting a log-in screen may be used.

Further, in the above described preferred embodiment, although the explanation was made as to the case where local IP addresses of client computers connected to the LAN are individually registered in the address list, it is not absolutely necessary to individually register local IP addresses of client computers connected to the LAN in an address list and a range of IP addresses of client computers connected to a LAN may be registered in an address list as reference data. Further, it is possible to automatically produce an address list by causing the server to search for IP addresses on the LAN and automatically update an address list by causing the server to regularly search for local IP addresses on the LAN and adding local IP addresses thereto or deleting local IP addresses therefrom. Furthermore, it is possible for the administrator of a network himself or herself to produce and update an address list.

Moreover, web pages include various web pages which are produced using program languages such as HTML, SGML, XML and the like and can be browsed using a web browser.

As described above, according to the present invention, it is possible to provide a log-in method for a client server system which enables a client computer to log in to a server accessible via the Internet or a LAN with high security and operability, a computer program for performing the log-in method and a recording medium in which the computer program is stored and the like.

1. A log-in method for a client server system constituted so as to display a predetermined log-in screen on a client computer, the server being constituted so as to obtain identification data of the client computer in response to a connection request from the client computer, judge based on the identification data of the client computer a network to which the client computer is connected, display a first log-in screen on the client computer when it judges that the network to which the client computer is connected is a first network, and display a second log-in screen on the client computer when it judges that the network to which the client computer is connected is a second network.

2. A log-in method in accordance with claim 1, wherein the second log-in screen is constituted so that it can be used more easily than the first log-in screen.

3. A log-in method in accordance with claim 1, wherein the first log-in screen is adapted to be directly input with both a log-in name and a password of a user and the second log-in screen is constituted so as to require a user to select a log-in name of the user and directly input a password of the user.

4. A log-in method in accordance with claim 1, wherein the first log-in screen is adapted to be directly input with both a log-in name and a password of a user and the second log-in screen is constituted so as to require a user to select a log-in name of the user in accordance with an auto-complete format and to directly input a password of the user.

5. A log-in method in accordance with claim 1, wherein the level of access restriction to the second log-in screen is determined to be higher than that to the first log-in screen.

6. A log-in method in accordance with claim 1, wherein the server is constituted so as to refer to a list in which at least the identification data of the client computer connected to the second network is registered when it judges a network the client computer is connected to based on the identification data.

7. A log-in method in accordance with claim 1, wherein the first network is constituted as the Internet and the second network is constituted as a local area network.

8. A log-in method in accordance with claim 7, wherein the identification data are constituted as an IP address and the server is constituted so as to refer to an address list in which at least IP addresses of client computers connected to the local area network are registered, judge that when the IP address is registered in the address list, a client computer having the IP address is connected to the local area network and judge that when the IP address is not registered in the address list, a client computer having the IP address is connected to the Internet.

9. A log-in method in accordance with claim 7, wherein the identification data are constituted as an IP address and the server is constituted so as to judge that when the IP address is a global IP address, a client computer having the IP address is connected to the Internet and judge that when the IP address is a local IP address, a client computer having the IP address is connected to the local area network.

10. A computer program for enabling a server in a client server system constituted so as to display a predetermined log-in screen on a client computer to execute at least a step of obtaining identification data of the client computer in response to a connection request from the client computer, a step of judging based on the identification data of the client computer a network to which the client computer is connected, a step of displaying a first log-in screen on the client computer when it is judged that the network to which the client computer is connected is a first network, and a step of displaying a second log-in screen on the client computer when it is judged that the network to which the client computer is connected is a second network.

11. A computer-readable recording medium in which is recorded a computer program for enabling a server in a client server system constituted so as to display a predetermined log-in screen on a client computer to execute at least a step of obtaining identification data of the client computer in response to a connection request from the client computer, a step of judging based on the identification data of the client computer a network to which the client computer is connected, a step of displaying a first log-in screen on the client computer when it is judged that the network to which the client computer is connected is a first network, and a step of displaying a second log-in screen on the client computer when it is judged that the network to which the client computer is connected is a second network.
